(19) United States
(12) Patent Application Publication
(10) Pub. No.: US 2013/0001329 A1
(43) Pub. Date: Jan. 3, 2013

(54) Atomizing nozzle with enhanced structural strength

(76) Inventor: Hui-Ju HSU, Taichung City (TW)

(21) Appl. No.: 13/135,297

(22) Filed: Jun. 30, 2011

(51) Int. Cl. B05B 1/00

(52) U.S. Cl. 239/589

(57) ABSTRACT

In an atomizing nozzle with enhanced structural strength, a body is connected to a cover, and a rotor is disposed in the body. Furthermore, the cover has a first surface and a second surface, and a depressed structure extends from the first surface of the cover toward the second surface, and has an opening on the first surface and a bottom disposed opposite the opening. A water jetting hole penetrates through the bottom of the depressed structure. Because the water jetting hole is disposed in the depressed structure, the peripheral structure of the water jetting hole has the greater thickness and the higher structural strength. Even if an external force is exerted, the water jetting hole and its periphery cannot deform.

### BACKGROUND OF THE INVENTION

1. Field of the Invention

The invention relates to the technological field of an atomizing device, and more particularly to an atomizing nozzle capable of atomizing and ejecting the water or liquid.

2. Related Art

A typical atomizing system or device may have an atomizing nozzle disposed at an outlet. When the water or liquid flows through the atomizing nozzle, a rotor disposed in a body of the atomizing nozzle and a water jetting hole of a cover of the atomizing nozzle can be utilized to atomize and eject the water or liquid.

In order to make the water or liquid successfully enter the atomizing state when it leaves the atomizing nozzle, the design of the water jetting hole must satisfy two principles of the small aperture and the thin periphery of the water jetting hole.

The outer surface of the end portion of the cover is usually formed into the flat plane structure. The water jetting hole penetrates through the outer surface and the inner surface of the end portion of the cover, and the water jetting hole is disposed at the center of the depressed arced surface of the inner surface of the end portion of the cover. Consequently, the periphery of the water jetting hole may be made thin.

However, the thin periphery of the water jetting hole tends to be impacted and deform so that the water jetting hole is damaged, and the ejecting of the water or liquid is obstructed.

### SUMMARY OF THE INVENTION

It is therefore an object of the invention to provide an atomizing nozzle with enhanced structural strength of the peripheral structure of the water jetting hole, so that the possibility of deformation of the water jetting hole and its periphery caused by the external force can be reduced.

According to the above-mentioned object and effects, the invention provides an atomizing nozzle including a body, a cover connected to the body, and a rotor disposed in the body.

More specifically, the body has one axial end formed with an inlet, and the other axial end formed with an outlet, wherein a passage connects the inlet to the outlet. The cover has a first surface and a second surface. Also, a depressed structure extending from the first surface of the cover to the second surface of the cover has an opening disposed on the first surface, and has a bottom disposed opposite the opening. A water jetting hole penetrates through the bottom of the depressed structure.

Because the water jetting hole is disposed in the depressed structure, the peripheral structure of the water jetting hole has the greater thickness and the higher structural strength. Thus, the external force cannot easily deform the water jetting hole and its periphery.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is an exploded view showing an embodiment of the invention.

FIGS. 2 and 3 are schematic illustrations showing structures of covers according to the embodiment of the invention.

### DETAILED DESCRIPTION OF THE INVENTION

The present invention will be apparent from the following detailed description, which proceeds with reference to the accompanying drawings, wherein the same references relate to the same elements.

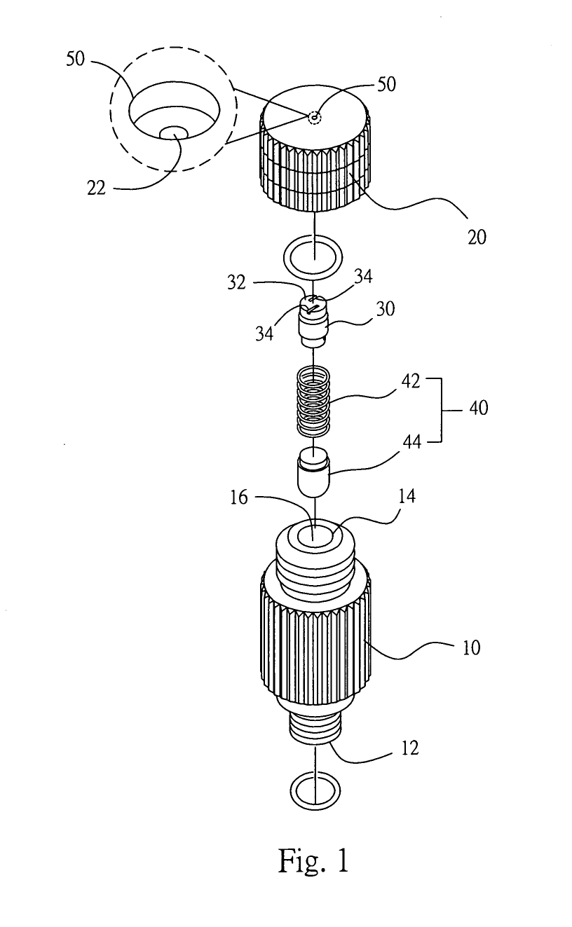

Referring to FIG. 1, an atomizing nozzle includes a body 10, a cover 20, a rotor 30 and a leakage-stopping assembly 40.

Specifically, the body 10 has one axial end formed with an inlet 12, the other axial end formed with an outlet 14, and an axial passage 16 connecting the inlet 12 to the outlet 14.

The cover 20 is disposed at one end of the body 10 and is disposed opposite the outlet 14. A water jetting hole 22 and a depressed structure 50 are formed on the cover 20, and the water jetting hole 22 communicates with the outlet 14. In addition, the cover 20 may be combined with the body 10 by way of, for example, screwing.

The rotor 30 is movably accommodated within the passage 16 of the body 10. The rotor 30 has a first end 32 formed with a notch 34. The leakage-stopping assembly 40 is a combination of a spring 42 and a plunger 44. The leakage-stopping assembly 40 is accommodated within the passage 16 and disposed between the rotor 30 and the inlet 12.

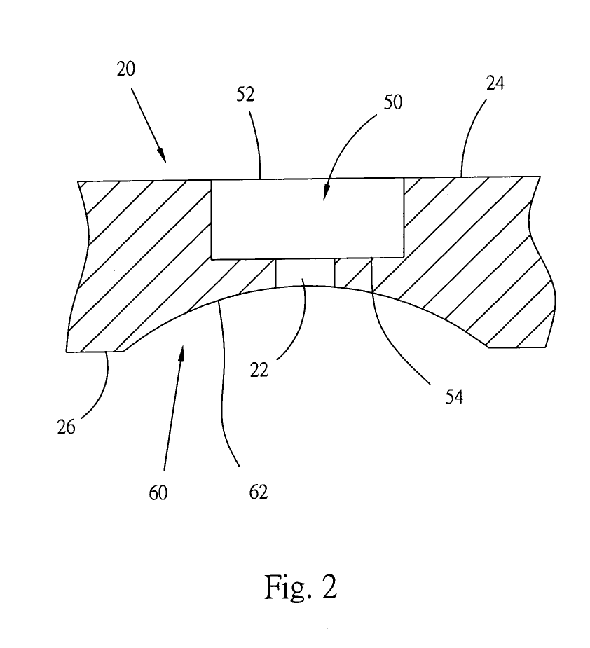

As shown in FIG. 2, the cover 20 of the invention has a first surface 24 and a second surface 26. The depressed structure 50 is formed on the cover 20, and extends from the first surface 24 toward the second surface 26.

The depressed structure 50 has an opening 52 and a bottom 54. The opening 52 is disposed on the first surface 24, the bottom 54 is close to the second surface 26, and the opening 52 is disposed opposite the bottom 54. Also, the water jetting hole 22 is disposed on the bottom 54 of the depressed structure 50.

As shown in the drawing, the water jetting hole 22 itself satisfies the features of the small aperture and the small thickness, and the depressed structure 50 on the periphery of the water jetting hole 22 provides the greater thickness. When the external force is exerted on the first surface 24, the acting force cannot easily reach the water jetting hole 22 and the bottom 54 of the depressed structure 50, so that the water jetting hole 22 and its periphery cannot easily deform. In other words, the depressed structure 50 has the effect of enhancing the structural strength of the periphery of the water jetting hole 22.

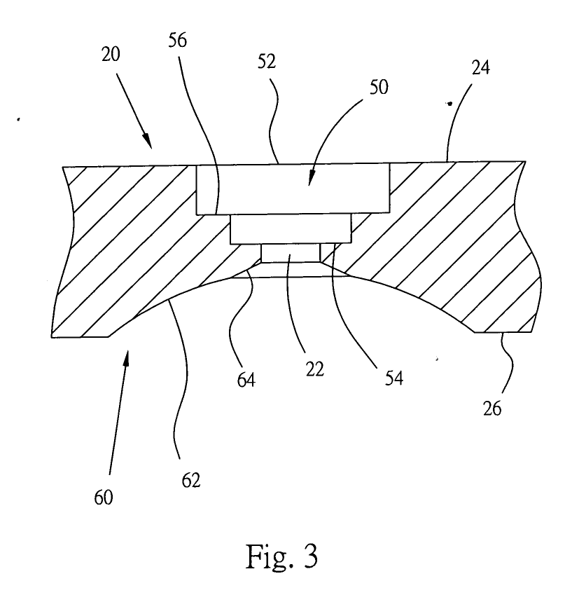

As shown in FIG. 3, the depressed structure 50 may be manufactured into a stepping structure. Specifically, the depressed structure 50 has a shoulder 56 disposed between the first surface 24 and the bottom 54. Thus, the inner diameter of the opening 52 has to be increased so that the water or liquid may have the greater spraying angle, and the shoulder 56 can further protect the water jetting hole 22.

Referring again to FIG. 2, a guiding structure 60 is formed on the second surface 26 of the cover 20 and has a curvature, and the water jetting hole 22 is a symmetrical center of the guiding structure 60. Thus, the water or liquid can be quickly guided to the water jetting hole 22. The guiding structure 60 of this embodiment is an arced surface 62.

Referring again to FIG. 3, the guiding structure 60 is formed on the second surface 26 of the cover 20. The water jetting hole 22 serves as the symmetrical center of the guiding structure 60. The guiding structure 60 includes the arced surface 62 and an inclined surface 64. The arced surface 62 is connected to the inclined surface 64, and the inclined surface 64 is connected to the water jetting hole 22.

The guiding structure 60 of the invention can decrease the thickness of the peripheral structure of the water jetting hole 22.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. An atomizing nozzle with enhanced structural strength, the atomizing nozzle comprising:
a body having one axial end formed with an inlet, the other axial end formed with an outlet, and a passage connecting the inlet to the outlet;
a cover, which is disposed at the outlet of the body and has a first surface and a second surface;
a rotor movably accommodated within the passage of the body;
a depressed structure, which extends from the first surface of the cover toward the second surface of the body, and has an opening on the first surface and a bottom disposed opposite the opening; and
a jetting hole, which penetrates through and is disposed on the bottom of the depressed structure.

2. The atomizing nozzle according to claim 1, wherein the depressed structure has a shoulder disposed between the first surface and the bottom.

3. The atomizing nozzle according to claim 1, further comprising a guiding structure, which is formed on the second surface of the cover and has a curvature, wherein the jetting hole is a symmetrical center of the guiding structure.

4. The atomizing nozzle according to claim 3, wherein the guiding structure is an arced surface.

5. The atomizing nozzle according to claim 3, wherein the guiding structure is an arced surface connected to an inclined surface, and the inclined surface is connected to the jetting hole.

6. The atomizing nozzle according to claim 1, further comprising a leakage-stopping assembly, which is a combination of a spring and a plunger, and is disposed in the passage and between the rotor and the inlet.
